(19) United States
(12) Patent Application Publication
(10) Pub. No.: US 2022/0383626 A1
(43) Pub. Date: Dec. 1, 2022

(54) IMAGE PROCESSING METHOD, MODEL TRAINING METHOD, RELEVANT DEVICES AND ELECTRONIC DEVICE

(71) Applicant: Beijing Baidu Netcom Science Technology Co., Ltd., Beijing (CN)

(72) Inventors: Jian WANG, Beijing (CN); Junyu HAN, Beijing (CN); Jinwen CHEN, Beijing (CN); Lufei LIU, Beijing (CN)

(21) Appl. No.: 17/883,248

(22) Filed: Aug. 8, 2022

(30) Foreign Application Priority Data
Jan. 26, 2022 (CN) 202210096251.9

(51) Int. Cl. G06V 10/77; G06V 10/771; G06V 10/80; G06V 10/50; G06V 10/82

(52) U.S. Cl. CPC G06V 10/7715; G06V 10/771; G06V 10/806; G06V 10/50; G06V 10/82

(57) ABSTRACT

An image processing method includes: obtaining a first categorical feature and M first image features corresponding to M first images respectively, each first image being associated with a task index, task indices associated with different first images being different from each other, M being a positive integer; fusing the M first image features with the first categorical feature respectively so as to obtain M first target features; performing feature extraction on the M first target features so as to obtain M second categorical features; selecting a second categorical feature corresponding to each task index from the M second categorical features, and performing regularization corresponding to the task index on the second categorical feature, to obtain a third categorical feature corresponding to the task index; and performing image processing in accordance with M third categorical features so as to obtain M first image processing results of the M first images.

### CROSS-REFERENCE TO RELATED APPLICATION

This application claims priority of the Chinese patent application No. 202210096251.9 filed on Jan. 26, 2022, which is incorporated herein by reference in its entirety.

### TECHNICAL FIELD

The present disclosure relates to the field of artificial intelligence technology, in particular to the field of computer vision technology and deep learning technology, more particularly to an image processing method, a model training method, relevant devices, and an electronic device.

### BACKGROUND

Along with the development of artificial intelligence technology, multitasking has been widely used. Multitasking refers to the processing of a plurality of tasks simultaneously through one model, so as to improve the task processing efficiency.

Currently, a multitasking mode usually includes processing each task through a separate network and then aggregating outputs of the tasks.

### SUMMARY

An object of the present disclosure is to provide an image processing method, a model training method, relevant devices, and an electronic device, so as to solve problems in the related art.

In a first aspect, the present disclosure provides in some embodiments an image processing method, including: obtaining a first categorical feature and M first image features corresponding to M first images respectively, each first image being associated with a task index, task indices associated with different first images being different from each other, M being a positive integer; fusing the M first image features with the first categorical feature respectively so as to obtain M first target features; performing feature extraction on the M first target features so as to obtain M second categorical features; selecting a second categorical feature corresponding to each task index from the M second categorical features, and performing regularization corresponding to the task index on the second categorical feature, so as to obtain a third categorical feature corresponding to the task index; and performing image processing in accordance with M third categorical features so as to obtain M first image processing results of the M first images.

In a second aspect, the present disclosure provides in some embodiments a model training method, including: obtaining a training sample set, the training sample set including N first images, each first image being associated with a task index, task indices associated with different first images being different from each other, N being an integer greater than 1; inputting the N first images into a target model to perform an image processing operation, so as to obtain N first image processing results of the N first images, the image processing operation including obtaining a first categorical feature and N first image features corresponding to the N first images respectively, fusing the N first image features with the first categorical feature so as to obtain N first target features, performing feature extraction on the N first target features so as to obtain N second categorical features, selecting a second categorical feature corresponding to each task index from the N second categorical features and performing regularization corresponding to the task index on the second categorical feature so as to obtain a third categorical feature corresponding to the task index, and performing image processing in accordance with N third categorical features so as to obtain the N first image processing results of the N first images; determining a network loss value corresponding to each task index in accordance with the N first image processing results; and updating a network parameter of the target model in accordance with N network loss values.

In a third aspect, the present disclosure provides in some embodiments an image processing device, including: a first obtaining module configured to obtain a first categorical feature and M first image features corresponding to M first images respectively, each first image being associated with a task index, task indices associated with different first images being different from each other, M being a positive integer; a fusion module configured to fuse the M first image features with the first categorical feature so as to obtain M first target features; a feature extraction module configured to perform feature extraction on the M first target features so as to obtain M second categorical features; a regularization module configured to select a second categorical feature corresponding to each task index from the M second categorical features, and perform regularization corresponding to the task index on the second categorical feature, so as to obtain a third categorical feature corresponding to the task index; and an image processing module configured to perform image processing in accordance with M third categorical features so as to obtain M first image processing results of the M first images.

In a fourth aspect, the present disclosure provides in some embodiments a model training device, including: a first obtaining module configured to obtain a training sample set, the training sample set including N first images, each first image being associated with a task index, task indices associated with different first images being different from each other, N being an integer greater than 1; an operation module configured to input the N first images into a target model to perform an image processing operation, so as to obtain N first image processing results of the N first images, the image processing operation including obtaining a first categorical feature and N first image features corresponding to the N first images respectively, fusing the N first image features with the first categorical feature so as to obtain N first target features, performing feature extraction on the N first target features so as to obtain N second categorical features, selecting a second categorical feature corresponding to each task index from the N second categorical features and performing regularization corresponding to the task index on the second categorical feature so as to obtain a third categorical feature corresponding to the task index, and performing image processing in accordance with N third categorical features so as to obtain the N first image processing results of the N first images; a determination module configured to determine a network loss value corresponding to each task index in accordance with the N first image processing results; and an updating module configured to update a network parameter of the target model in accordance with N network loss values.

In a fifth aspect, the present disclosure provides in some embodiments an electronic device, including at least one processor, and a memory in communication with the at least one processor. The memory is configured to store therein an instruction to be executed by the at least one processor, and the instruction is executed by the at least one processor so as to implement the image processing method in the first aspect or the model training method in the second aspect.

In a sixth aspect, the present disclosure provides in some embodiments a non-transitory computer-readable storage medium storing therein a computer instruction. The computer instruction is executed by a computer so as to implement the image processing method in the first aspect or the model training method in the second aspect.

In a seventh aspect, the present disclosure provides in some embodiments a computer program product including a computer program. The computer program is executed by a processor so as to implement the image processing method in the first aspect or the model training method in the second aspect.

According to the embodiments of the present disclosure, it is able to solve the problem in the related art where an image processing effect is not ideal during the multitasking, thereby to improve the image processing effect during the multitasking.

It should be understood that, this summary is not intended to identify key features or essential features of the embodiments of the present disclosure, nor is it intended to be used to limit the scope of the present disclosure. Other features of the present disclosure will become more comprehensible with reference to the following description.

### BRIEF DESCRIPTION OF THE DRAWINGS

The following drawings are provided to facilitate the understanding of the present disclosure, but shall not be construed as limiting the present disclosure. In these drawings,

FIG. 1 is a flow chart of an image processing method according to a first embodiment of the present disclosure;

FIG. 2 is a schematic view showing the processing of a task through a target model;

FIG. 3 is a flow chart of a model training method according to a second embodiment of the present disclosure;

FIG. 4 is a schematic view showing the training process of the target model;

FIG. 5 is a schematic view showing an image processing device according to a third embodiment of the present disclosure;

FIG. 6 is a schematic view showing a model training device according to a fourth embodiment of the present disclosure; and

FIG. 7 is a block diagram of an electronic device according to one embodiment of the present disclosure.

### DETAILED DESCRIPTION

In the following description, numerous details of the embodiments of the present disclosure, which should be deemed merely as exemplary, are set forth with reference to accompanying drawings to provide a thorough understanding of the embodiments of the present disclosure. Therefore, those skilled in the art will appreciate that modifications or replacements may be made in the described embodiments without departing from the scope and spirit of the present disclosure. Further, for clarity and conciseness, descriptions of known functions and structures are omitted.

### First Embodiment

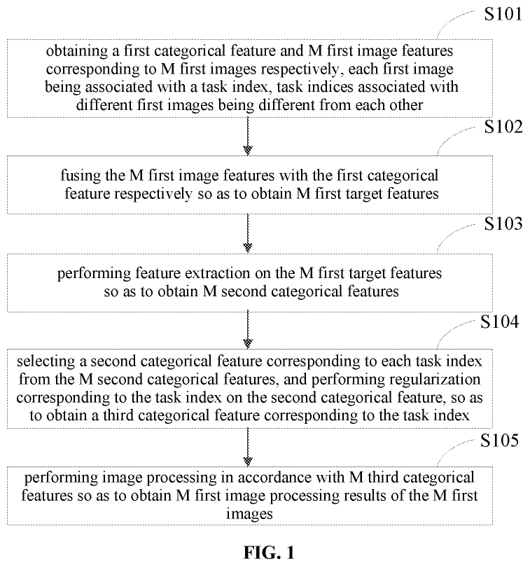

As shown in FIG. 1, the present disclosure provides in this embodiment an image processing method, which includes the following steps.

Step S101: obtaining a first categorical feature and M first image features corresponding to M first images respectively, each first image being associated with a task index, task indices associated with different first images being different from each other, M being a positive integer.

In this embodiment of the present disclosure, the image processing method relates to the field of artificial intelligence technology, in particular to the field of computer vision technology and deep learning technology, and it is widely applied in such scenarios as image processing and image detection. The image processing method in the embodiments of the present disclosure is implemented by an image processing device. The image processing device is configured in any electronic device so as to implement the image processing method. The electronic device is a server or a terminal, which will not be particularly defined herein.

In this embodiment of the present disclosure, the image processing refers to image recognition or image segmentation. Taking image recognition as an example, task processing is performed through a target model. To be specific, at least one image is inputted into the target model for image recognition, and each image corresponds to one image recognition task, e.g., face recognition is performed with respect to one image, human recognition is performed with respect to another image, and vehicle recognition is performed with respect to yet another image. The image recognition tasks corresponding to different images may be the same or different, which will not be particularly defined herein.

It should be appreciated that, in the case that at least two images are inputted into the target model for image processing, the target model may perform a multitasking operation so as to obtain an image processing result of each image. The target model is a deep learning model, e.g., a visual Transformer model.

The first image is any image, and an image content of the first image usually matches a task corresponding to a task index. For example, when the task corresponding to the task index is face recognition, the first image usually includes a face, and when the task corresponding to the task index is vehicle recognition, the first image usually includes a vehicle.

All image processing tasks to be performed through the target model are indexed to obtain the task index of each task, and then the first image is associated with the corresponding task index in accordance with the image processing task to be performed. For example, when the image processing task to be performed is face recognition, the first image is associated with a task index of a face recognition task.

In addition, in the case that at least two first images have been obtained, the task indices associated with different first images are different, so as to perform the multitasking.

The first image is obtained in various ways. For example, an image captured by a camera in real time is taken as the first image, or a pre-stored image is obtained as the first image, or the first image is downloaded from the network, or the first image is received from the other electronic device. The M first images are obtained in one or more of the above-mentioned ways.

The M first images and the M task indices associated with the M first images respectively constitute a group of data for batch processing, i.e., they constitute a batch and are inputted into the target model. The task index serves as an auxiliary input, and it is used when indexing a task feature, which will be described hereinafter in details.

The first categorical feature refers to a feature for classification, and it is also called as class token. The first categorical feature is a vector, e.g., a vector having a size of 1*256.

The first categorical feature is a randomly-generated or pre-stored initial categorical feature, which will not be particularly defined herein.

In a possible embodiment of the present disclosure, the first image is processed as an entirety to constitute the first image feature. In this embodiment of the present disclosure, the first image feature is a vector.

In another possible embodiment of the present disclosure, the first image is divided into K image blocks, where K is an integer greater than 1. Next, an image feature of each image block is obtained. Then, the image features of the K image blocks are fused to obtain the first image feature. In this embodiment of the present disclosure, the image feature of each image block is a vector, e.g., a vector having a size of 1*256. The image features of the K image blocks are fused to obtain the first image feature in the form of a matrix. For example, when K is 9, the first image feature is a 9*256 matrix. In this way, it is able to improve a feature representation ability of the image.

The target model includes an embedding layer. The first categorical feature and the M first image features corresponding to the M first images are obtained through the embedding layer. In a possible embodiment of the present disclosure, the M first images are inputted into the target model. The target model performs the feature representation on the M first images through the embedding layer, and randomly generates a first categorical feature or obtains a pre-stored first categorical feature.

Step S102: fusing the M first image features with the first categorical feature respectively so as to obtain M first target features.

In this step, with respect to each task index in the M task indices, the first image feature corresponding to the task index is fused with the first categorical feature so as to obtain the first target feature. For example, when the first categorical feature is a vector having a size of 1*256 and the first image feature is a 9*256 matrix, the first target feature obtained through fusion is a 10*256 matrix.

After obtaining the M first target features, the M first target features are inputted into a feature extraction network of the target model.

Step S103: performing feature extraction on the M first target features so as to obtain M second categorical features.

In this step, the feature extraction network of the target model performs, through one channel, the feature extraction on each first target feature in the M first target features, so as to obtain the M second categorical features. To be specific, with respect to each first target feature, the feature extraction network of the target model extracts the first image feature to the first categorical feature, so as to obtain a second categorical feature having a transition relation with the first categorical feature.

Through training the target model, a transition relation for each task is determined. The transition relations for the tasks are different, and feature extraction capabilities are different too. In a possible embodiment of the present disclosure, the feature extraction network merely includes a single network, and after the training, a first network parameter of the feature extraction network is used to represent the transition relation for each task. The target model is trained so as to determine the first network parameter, thereby to accurately represent the transition relation for each task. In this way, with respect to the first image corresponding to each task, it is able to extract the second categorical feature in the task having a specific transition relation with the first categorical feature from the first image feature in accordance with the first categorical feature and the first image feature.

Step S104: selecting a second categorical feature corresponding to each task index from the M second categorical features, and performing regularization corresponding to the task index on the second categorical feature, so as to obtain a third categorical feature corresponding to the task index.

The data distribution among the M second categorical features for the tasks is greatly different, and when a uniform regularization operation is adopted, it is impossible to accurately determine the data distribution for different tasks, so the image processing effect is not ideal.

In this embodiment of the present disclosure, with respect to each task index, the second categorical feature corresponding to the task index is selected from the M second categorical features, and then subjected to regularization corresponding to the task index, so as to accurately determine the data distribution for the task corresponding to the task index, thereby to improve the image processing effect.

For example, three tasks with an index 1, an index 2 and an index 3 are processed by the target model simultaneously. After training the target model, feature data of a task corresponding to the index 1 outputted by the target model is distributed within 0 to 0.8, feature data of a task corresponding to the index 2 is distributed within 0.6 to 0.8, and feature data of a task corresponding to the index 3 is distributed within 0.4 to 0.6. Correspondingly, with respect to each task index, the regularization corresponding to the task index is performed on the second categorical feature corresponding to the task index, so as to obtain the third categorical feature. Data distribution of the third categorical feature is the same as the distribution of the feature data of the task corresponding to the task index. In this way, it is able to differentiate the categorical features for different tasks in accordance with the distribution of the feature data, and enable the tasks to be separated from each other, thereby to improve the image processing effect during the multitasking.

During the regularization corresponding to the task index, usually first feature statistical information needs to be used. The first feature statistical information includes two parameters, i.e., a feature data average and a data feature variance. In a possible embodiment of the present disclosure, the feature data average and the feature data variance corresponding to the task index are obtained through training the target model.

In another possible embodiment of the present disclosure, feature counting is performed on the second categorical feature corresponding to the task index so as to obtain first feature statistical information. The first feature statistical information includes a feature data average and a feature data variance corresponding to the task index.

Correspondingly, the performing the regularization corresponding to the task index on the second categorical feature specifically includes performing a normalization operation on the second categorical feature corresponding to the task index. The normalization operation includes subtracting the feature data average corresponding to the task index from data in the second categorical feature corresponding to the task index, and dividing a resultant value by the feature data variance corresponding to the task index.

Step S105: performing image processing in accordance with M third categorical features so as to obtain M first image processing results of the M first images.

In this step, with respect to each task index, the image processing is performed in accordance with the third categorical feature corresponding to the task index, so as to obtain the first image processing result of the first image for the task.

For example, when M is 3, the task indices include a task index 1, a task index 2 and a task index 3, a first image A is associated with the task index 1, a first image B is associated with the task index 2, and a first image C is associated with the task index 3. A third categorical feature corresponding to the task index 1 is obtained, and then the image processing is performed in accordance with the third categorical feature so as to obtain a first image processing result of the first image A. A third categorical feature corresponding to the task index 2 is obtained, and then the image processing is performed in accordance with the third categorical feature so as to obtain a first image processing result of the first image B. A third categorical feature corresponding to the task index 3 is obtained, and then the image processing is performed in accordance with the third categorical feature so as to obtain a first image processing result of the first image C.

The M third categorical features are inputted into an image processing method of the target model. The image processing network is a classifier network for performing the image processing on the third categorical feature corresponding to each task to obtain the M first image processing results corresponding to the M first images respectively.

Alternatively, after the third categorical feature corresponding to each task has been indexed in accordance with the task index, the third categorical feature is inputted into each image processing network for the corresponding task, and then the image processing network outputs the first image processing result of the first image.

In this embodiment of the present disclosure, the task index serves as an auxiliary input. With respect to each task index, the second categorical feature corresponding to the task index is selected from the M second categorical features, and the regularization corresponding to the task index is performed on the second categorical feature so as to obtain the third categorical feature corresponding to the task index. In this way, it is able to differentiate the categorical features for different tasks from each other in accordance with the distribution of the feature data, enable the tasks to be separated from each other, and reduce the occurrence of a conflict among the tasks, thereby to improve the image processing effect during the multitasking.

In a possible embodiment of the present disclosure, Step S104 specifically includes: performing feature counting on the second categorical feature corresponding to the task index selected from the M second categorical features, so as to obtain first feature statistical information about a task corresponding to the task index; and performing a normalization operation on the second categorical feature corresponding to the task index in accordance with the first feature statistical information, so as to obtain the third categorical feature corresponding to the task index.

In this embodiment of the present disclosure, the feature counting is performed on the second categorical feature corresponding to the task index so as to obtain the first feature statistical information. The first feature statistical information includes a feature data average and a feature data variance corresponding to the task index.

The normalization operation includes subtracting the feature data average corresponding to the task index from data in the second categorical feature corresponding to the task index, and dividing a resultant value by the feature data variance corresponding to the task index, so as to obtain the third categorical feature corresponding to the task index.

In this embodiment of the present disclosure, the feature counting is performed on the second categorical feature corresponding to the task index selected from the M second categorical features, so as to obtain the first feature statistical information about the task corresponding to the task index. Then, the normalization operation is performed on the second categorical feature corresponding to the task index in accordance with the first feature statistical information, so as to obtain the third categorical feature corresponding to the task index. In this way, with respect to each task index, the regularization corresponding to the task index is performed in accordance with the second categorical feature obtained actually, so as to obtain the third categorical feature in a more accurate manner through the regularization, thereby to further improve the image processing effect.

In a possible embodiment of the present disclosure, Step S103 specifically includes performing the feature extraction on each first target feature in the M first target features in accordance with a first network parameter of a feature extraction network in the target model so as to obtain the M second categorical features.

In this embodiment of the present disclosure, the task processing is performed through the target model, the target model includes a feature extraction network and an image processing network, and the image processing method is a classifier network.

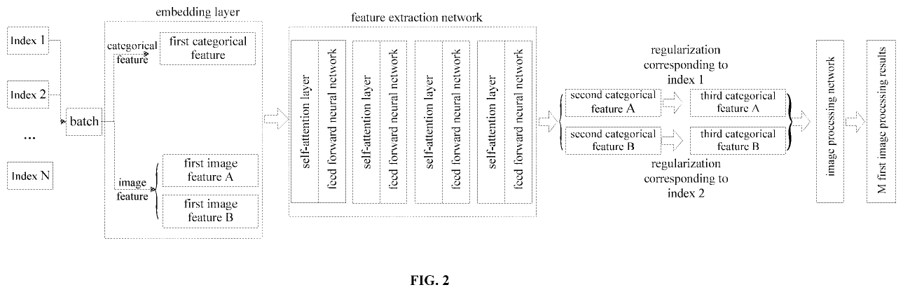

FIG. 2 shows the task processing performed through the target model. As shown in FIG. 2, all tasks to be processed by the target model are indexed as index 1, index 2, . . . , index N, i.e., at most N tasks are processed by the target model.

The M first images are inputted into the target model, and the M first images are associated with the task indices in accordance with the image processing task to be performed. For example, when M is 2, a face recognition task needs to be performed for the first image A and a task corresponding to the index 1 is a face recognition task, the first image A is associated with the index 1. When a human recognition task is to be performed for the first image B and a task corresponding to the index 2 is a human recognition task, the first image B is associated with the index 2.

After the association, the M first images and the corresponding task indices are inputted as a batch into the target model. An embedding layer of the target model obtains a first categorical feature and the M first image features, i.e., a first image feature A and a second image feature B. The first categorical feature is fused with the first image feature A to obtain a first target feature A, and the first categorical feature is fused with the first image feature B to obtain a first target feature B.

The first target feature A and the first target feature B are inputted into the feature extraction network of the target model. As shown in FIG. 2, the feature extraction network is a visual Transformer network which includes a plurality of encoders, and each encoder includes a self-attention layer and a feed forward neural network. The feature extraction network performs the feature extraction on each first target feature in the M first target features (e.g., the first target feature A and the first target feature B) in accordance with a same first network parameter, so as to obtain the M second categorical features, e.g., a second categorical feature A and a second categorical feature B.

After obtaining the M second categorical features, with respect to each task index, the regularization corresponding to the task index is performed on the second categorical feature corresponding to the task index in the M second categorical features, so as to obtain the third categorical feature corresponding to the task index.

The M third categorical features (the third categorical feature A and the third categorical feature B) are inputted into the image processing network. The image processing network performs image processing on each third categorical feature so as to obtain the M first image processing results corresponding to the M first images respectively.

In this embodiment of the present disclosure, a plurality of tasks shares one feature extraction network so as to obtain the M second categorical features. With respect to each task index, the second categorical feature corresponding to the task index is selected from the M second categorical features, and the regularization corresponding to the task index is performed on the second categorical feature, so as to obtain the third categorical feature corresponding to the task index. In this way, it is able to differentiate the categorical features for different tasks in accordance with the distribution of the feature data, and enable the tasks to be separated from each other, thereby to improve the image processing effect, provide the model with a simple structure and reduce the quantity of branches.

In a possible embodiment of the present disclosure, the first image feature corresponding to the first image is obtained through: dividing the first image into K image blocks, K being an integer greater than 1; obtaining an image feature of each image block; and fusing the image features of the K image blocks so as to obtain the first image feature.

In this embodiment of the present disclosure, the first image feature is a matrix, and it is divided into K image blocks, e.g., 9 image blocks, through an existing or new division mode.

Feature representation is performed on each image block through the embedding layer of the target model, so as to obtain the image feature of each image block. The image feature of each image block is a vector, e.g., a vector having a size of 1*256.

The image features of the K image blocks are fused to obtain the first image feature in the form of a matrix. For example, when K is 9, the image features of the 9 image blocks are spliced to obtain the first image feature in the form of a 9*256 matrix. In this way, it is able to improve the feature representation ability of the image.

### Second Embodiment

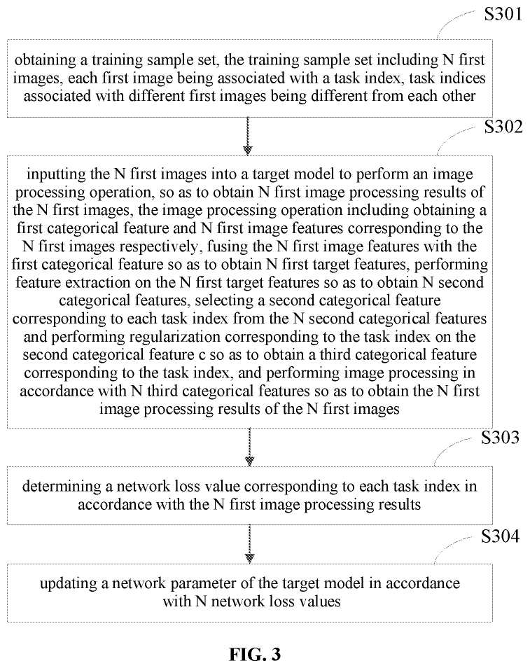

As shown in FIG. 3, the present disclosure provides in this embodiment a model training method, which includes: Step S301 of obtaining a training sample set, the training sample set including N first images, each first image being associated with a task index, task indices associated with different first images being different from each other, N being an integer greater than 1; Step S302 of inputting the N first images into a target model to perform an image processing operation, so as to obtain N first image processing results of the N first images, the image processing operation including obtaining a first categorical feature and N first image features corresponding to the N first images respectively, fusing the N first image features with the first categorical feature so as to obtain N first target features, performing feature extraction on the N first target features so as to obtain N second categorical features, selecting a second categorical feature corresponding to each task index from the N second categorical features and performing regularization corresponding to the task index on the second categorical feature so as to obtain a third categorical feature corresponding to the task index, and performing image processing in accordance with N third categorical features so as to obtain the N first image processing results of the N first images; Step S303 of determining a network loss value corresponding to each task index in accordance with the N first image processing results; and Step S304 of updating a network parameter of the target model in accordance with N network loss values.

A training process of the target model is described in this embodiment of the present disclosure. The target model is capable of processing at most N tasks, where N is usually greater than or equal to M, and M represents the quantity of image processing tasks to be performed by the target model.

The training sample set includes training data about each task. With respect to one task, its training data includes a first image for the task (the first image is a training sample image) and an image category label of the first image. The first image in the training process of the target model (i.e., the first image in the training data) may be the same as, or different from, the first image in the image processing through the target model, which will not be particularly defined herein.

The first image in the training sample set is obtained in a similar way as the first image in the first embodiment of the present disclosure, which will thus not be particularly defined herein. The image category label of the first image in the training sample is manually or automatically annotated, which will not be particularly defined herein.

The first image for each task in the training sample set is obtained, and then each first image is associated with the task index of the task to be performed.

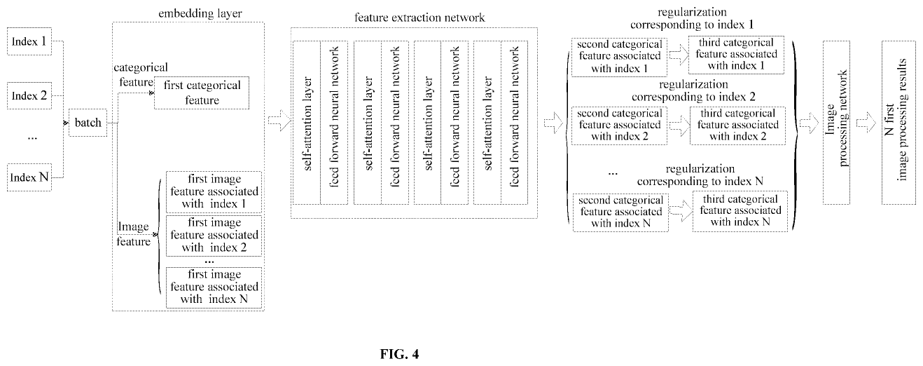

FIG. 4 shows a training process of the target model. As shown in FIG. 4, all the tasks for the target model are indexed as index 1, index 2, . . . , index N. The training data about different tasks in the training sample set is extracted to constitute a batch, and then inputted into the target model. In the batch, the training data about each task includes one first image associated with the task index and an image category label of the first image.

Correspondingly, the target model performs the image processing on the basis of the batch. To be specific, the target model includes an embedding layer, a feature extraction network and an image processing network. The embedding layer randomly generates a first categorical feature or obtains a pre-stored first categorical feature, and performs the feature representation on each first image, so as to obtain the N first image features corresponding to the N first images respectively. In this embodiment of the present disclosure, the first image feature is obtained in a similar way as the first image feature in the first embodiment of the present disclosure, which will thus not be particularly defined herein.

The N first image features are fused with the first categorical feature to obtain the N first target features. A fusion way is similar to the way of fusing the M first image features with the first categorical feature in the first embodiment of the present disclosure, which will thus not be particularly defined herein.

After obtaining the N first target features, the N first target features are inputted into the feature extraction network. The feature extraction network performs the feature extraction on each first target feature in accordance with a same first network parameter, so as to obtain the N second categorical features.

With respect to each task index, the second categorical feature corresponding to the task index is selected from the N second categorical features, and then the regularization corresponding to the task index is performed on the second categorical feature so as to obtain the third categorical feature corresponding to the task index.

The N third categorical features are inputted into the image processing network, and the image processing network performs the image processing on each third categorical feature so as to obtain the N first image processing results corresponding to the N first images respectively.

Next, with respect to each first image processing result, a difference between the first image processing result and the image category label of the corresponding first image is calculated, and then the network loss value of the task index corresponding to the first image processing result is determined in accordance with the difference, i.e., the network loss value of the task corresponding to the task index is determined, so as to obtain N network loss values of N tasks.

The N network loss values are summated, and the network parameter of the target model is updated in accordance with a sum of the N network loss values through backward propagation. The network parameter of the target model is iteratively updated, so that the sum of the network loss values of the tasks is minimum. At this time, the training is completed. The network parameter includes a first network parameter of the feature extraction network.

In this embodiment of the present disclosure, the task index serves as an auxiliary input. With respect to each task index, the second categorical feature corresponding to the task index is selected from the M second categorical features, the regularization corresponding to the task index is performed on the second categorical feature so as to obtain the third categorical feature corresponding to the task index, and then the network loss value is calculated in accordance with the third categorical feature so as to update the network parameter of the target model. In this way, it is able to differentiate the categorical features for different tasks from each other in accordance with the distribution of the feature data, and enable the tasks to be separated from each other, thereby to improve the image processing effect during the multitasking.

In a possible embodiment of the present disclosure, prior to selecting the second categorical feature corresponding to each task index from the N second categorical features and performing regularization corresponding to the task index on the second categorical feature so as to obtain the third categorical feature corresponding to the task index, the model training method further includes obtaining historical feature statistical information about a task corresponding to the task index, wherein the selecting the second categorical feature corresponding to each task index from the N second categorical features and performing regularization corresponding to the task index on the second categorical feature x so as to obtain the third categorical feature corresponding to the task index includes: determining second feature statistical information about the task corresponding to the task index in accordance with the historical feature statistical information and the second categorical feature corresponding to the task index; and performing a normalization operation on the second categorical feature corresponding to the task index in accordance with the second feature statistical information, so as to obtain the third categorical feature corresponding to the task index.

In this embodiment of the present disclosure, during the training, the feature counting is performed on all the second categorical features for the task corresponding to the task index through batch regularization, so as to obtain the second feature statistical information corresponding to the task index. To be specific, the batch regularization includes obtaining the historical feature statistical information about the task corresponding to the task index, performing the feature counting on the second categorical feature corresponding to the task index to obtain the corresponding feature statistical information, and performing average processing on the historical feature statistical information and the feature statistical information so as to obtain the second feature statistical information about the task corresponding to the task index.

For example, when the historical feature data about the task corresponding to the task index has an average value of 10 and the feature data obtained through the feature counting on the second categorical feature corresponding to the task index has an average value 10, the feature data in the second feature statistical information obtained through the average processing has an average value of 15.

Correspondingly, the normalization operation is performed on the second categorical feature corresponding to the task index in accordance with the second feature statistical information, so as to obtain the third categorical feature corresponding to the task index. The normalization operation in the training process is similar to the normalization operation in the first embodiment of the present disclosure, which will thus not be particularly defined herein.

In this embodiment of the present disclosure, the historical feature statistical information about the task corresponding to the task index is obtained, the second feature statistical information about the task corresponding to the task index is determined in accordance with the historical feature statistical information and the second categorical feature corresponding to the task index, and then the normalization operation is performed on the second categorical feature corresponding to the task index in accordance with the second feature statistical information, so as to obtain the third categorical feature corresponding to the task index. In this way, it is able to reduce the occurrence of a conflict among the tasks caused when the data distribution between the categorical features for the tasks is greatly different and it is impossible to accurately determine the data distribution for different tasks through uniform regularization, thereby to improve a joint training effect during the multitasking.

### Third Embodiment

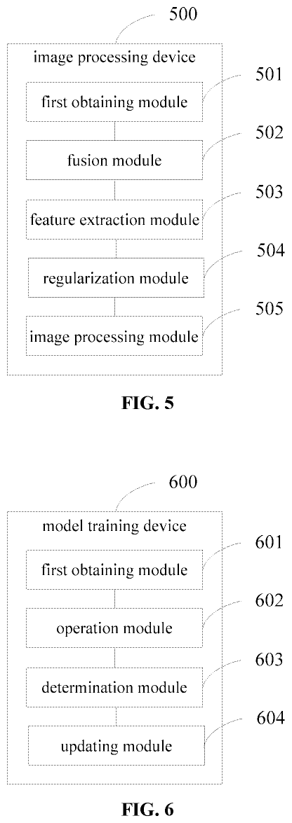

As shown in FIG. 5, the present disclosure provides in this embodiment an image processing device 500, which includes: a first obtaining module 501 configured to obtain a first categorical feature and M first image features corresponding to M first images respectively, each first image being associated with a task index, task indices associated with different first images being different from each other, M being a positive integer; a fusion module 502 configured to fuse the M first image features with the first categorical feature so as to obtain M first target features; a feature extraction module 503 configured to perform feature extraction on the M first target features so as to obtain M second categorical features; a regularization module 504 configured to select a second categorical feature corresponding to each task index from the M second categorical features, and perform regularization corresponding to the task index on the second categorical feature, so as to obtain a third categorical feature corresponding to the task index; and an image processing module 505 configured to perform image processing in accordance with M third categorical features so as to obtain M first image processing results of the M first images.

In a possible embodiment of the present disclosure, the regularization module 504 is specifically configured to: perform feature counting on the second categorical feature corresponding to the task index selected from the M second categorical features, so as to obtain first feature statistical information about a task corresponding to the task index; and perform a normalization operation on the second categorical feature corresponding to the task index in accordance with the first feature statistical information, so as to obtain the third categorical feature corresponding to the task index.

In a possible embodiment of the present disclosure, the feature extraction module 503 is specifically configured to perform the feature extraction on each first target feature in the M first target features in accordance with a first network parameter of a feature extraction network in a target model so as to obtain the M second categorical features.

In a possible embodiment of the present disclosure, the first image feature corresponding to the first image is obtained through: dividing the first image into K image blocks, K being an integer greater than 1; obtaining an image feature of each image block; and fusing the image features of the K image blocks so as to obtain the first image feature.

The image processing device 500 in this embodiment of the present disclosure is used to implement the above-mentioned image processing method with a same beneficial effect, which will not be particularly defined herein.

### Fourth Embodiment

As shown in FIG. 6, the present disclosure provides in this embodiment a model training device 600, which includes: a first obtaining module 601 configured to obtain a training sample set, the training sample set including N first images, each first image being associated with a task index, task indices associated with different first images being different from each other, N being an integer greater than 1; an operation module 602 configured to input the N first images into a target model to perform an image processing operation, so as to obtain N first image processing results of the N first images, the image processing operation including obtaining a first categorical feature and N first image features corresponding to the N first images respectively, fusing the N first image features with the first categorical feature so as to obtain N first target features, performing feature extraction on the N first target features so as to obtain N second categorical features, selecting a second categorical feature corresponding to each task index from the N second categorical features and performing regularization corresponding to the task index on the second categorical feature so as to obtain a third categorical feature corresponding to the task index, and performing image processing in accordance with N third categorical features so as to obtain the N first image processing results of the N first images; a determination module 603 configured to determine a network loss value corresponding to each task index in accordance with the N first image processing results; and an updating module 604 configured to update a network parameter of the target model in accordance with N network loss values.

In a possible embodiment of the present disclosure, the model training device further includes a second obtaining module configured to obtain historical feature statistical information about a task corresponding to the task index. The operation module 602 includes a regularization unit configured to: determine second feature statistical information about the task corresponding to the task index in accordance with the historical feature statistical information and the second categorical feature corresponding to the task index; and perform a normalization operation on the second categorical feature corresponding to the task index in accordance with the second feature statistical information, so as to obtain the third categorical feature corresponding to the task index.

The model training device 600 in this embodiment of the present disclosure is used to implement the above-mentioned model training method with a same beneficial effect, which will not be particularly defined herein.

The collection, storage, usage, processing, transmission, supply and publication of personal information involved in the embodiments of the present disclosure comply with relevant laws and regulations, and do not violate the principle of the public order.

The present disclosure further provides in some embodiments an electronic device, a computer-readable storage medium and a computer program product.

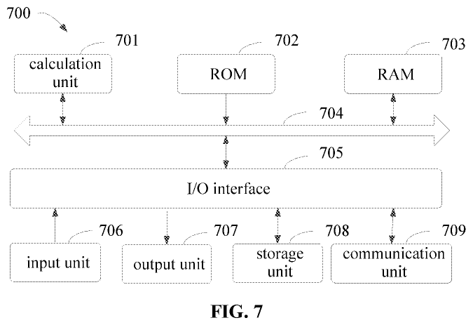

FIG. 7 is a schematic block diagram of an exemplary electronic device in which embodiments of the present disclosure may be implemented. The electronic device is intended to represent all kinds of digital computers, such as a laptop computer, a desktop computer, a work station, a personal digital assistant, a server, a blade server, a main frame or other suitable computers. The electronic device may also represent all kinds of mobile devices, such as a personal digital assistant, a cell phone, a smart phone, a wearable device and other similar computing devices. The components shown here, their connections and relationships, and their functions, are meant to be exemplary only, and are not meant to limit implementations of the present disclosure described and/or claimed herein.

As shown in FIG. 7, the electronic device 700 includes a computing unit 701 configured to execute various processings in accordance with computer programs stored in a Read Only Memory (ROM) 702 or computer programs loaded into a Random Access Memory (RAM) 703 via a storage unit 708. Various programs and data desired for the operation of the electronic device 700 may also be stored in the RAM 703. The computing unit 701, the ROM 702 and the RAM 703 may be connected to each other via a bus 704. In addition, an input/output (I/O) interface 705 may also be connected to the bus 704.

Multiple components in the electronic device 700 are connected to the I/O interface 707. The multiple components include: an input unit 705, e.g., a keyboard, a mouse and the like; an output unit 707, e.g., a variety of displays, loudspeakers, and the like; a storage unit 708, e.g., a magnetic disk, an optic disk and the like; and a communication unit 709, e.g., a network card, a modem, a wireless transceiver, and the like. The communication unit 709 allows the electronic device 700 to exchange information/data with other devices through a computer network and/or other telecommunication networks, such as the Internet.

The computing unit 701 may be any general purpose and/or special purpose processing components having a processing and computing capability. Some examples of the computing unit 701 include, but are not limited to: a central processing unit (CPU), a graphic processing unit (GPU), various special purpose artificial intelligence (AI) computing chips, various computing units running a machine learning model algorithm, a digital signal processor (DSP), and any suitable processor, controller, microcontroller, etc. The computing unit 701 carries out the aforementioned methods and processes, e.g., the image processing method or the model training method. For example, in some embodiments of the present disclosure, the image processing method or the model training method may be implemented as a computer software program tangibly embodied in a machine readable medium such as the storage unit 708. In some embodiments of the present disclosure, all or a part of the computer program may be loaded and/or installed on the electronic device 700 through the ROM 702 and/or the communication unit 709. When the computer program is loaded into the RAM 703 and executed by the computing unit 701, one or more steps of the foregoing image processing method or the model training method may be implemented. Optionally, in some other embodiments of the present disclosure, the computing unit 701 may be configured in any other suitable manner (e.g., by means of firmware) to implement the image processing method or the model training method.

Various implementations of the aforementioned systems and techniques may be implemented in a digital electronic circuit system, an integrated circuit system, a field-programmable gate array (FPGA), an application specific integrated circuit (ASIC), an application specific standard product (ASSP), a system on a chip (SOC), a complex programmable logic device (CPLD), computer hardware, firmware, software, and/or a combination thereof. The various implementations may include an implementation in form of one or more computer programs. The one or more computer programs may be executed and/or interpreted on a programmable system including at least one programmable processor. The programmable processor may be a special purpose or general purpose programmable processor, may receive data and instructions from a storage system, at least one input device and at least one output device, and may transmit data and instructions to the storage system, the at least one input device and the at least one output device.

Program codes for implementing the methods of the present disclosure may be written in one programming language or any combination of multiple programming languages. These program codes may be provided to a processor or controller of a general purpose computer, a special purpose computer, or other programmable data processing device, such that the functions/operations specified in the flow diagram and/or block diagram are implemented when the program codes are executed by the processor or controller. The program codes may be run entirely on a machine, run partially on the machine, run partially on the machine and partially on a remote machine as a standalone software package, or run entirely on the remote machine or server.

In the context of the present disclosure, the machine readable medium may be a tangible medium, and may include or store a program used by an instruction execution system, device or apparatus, or a program used in conjunction with the instruction execution system, device or apparatus. The machine readable medium may be a machine readable signal medium or a machine readable storage medium. The machine readable medium includes, but is not limited to: an electronic, magnetic, optical, electromagnetic, infrared, or semiconductor system, device or apparatus, or any suitable combination thereof. A more specific example of the machine readable storage medium includes: an electrical connection based on one or more wires, a portable computer disk, a hard disk, a random access memory (RAM), a read only memory (ROM), an erasable programmable read only memory (EPROM or flash memory), an optic fiber, a portable compact disc read only memory (CD-ROM), an optical storage device, a magnetic storage device, or any suitable combination thereof.

To facilitate user interaction, the system and technique described herein may be implemented on a computer. The computer is provided with a display device (for example, a cathode ray tube (CRT) or liquid crystal display (LCD) monitor) for displaying information to a user, a keyboard and a pointing device (for example, a mouse or a track ball). The user may provide an input to the computer through the keyboard and the pointing device. Other kinds of devices may be provided for user interaction, for example, a feedback provided to the user may be any manner of sensory feedback (e.g., visual feedback, auditory feedback, or tactile feedback); and input from the user may be received by any means (including sound input, voice input, or tactile input).

The system and technique described herein may be implemented in a computing system that includes a back-end component (e.g., as a data server), or that includes a middle-ware component (e.g., an application server), or that includes a front-end component (e.g., a client computer having a graphical user interface or a Web browser through which a user can interact with an implementation of the system and technique), or any combination of such back-end, middleware, or front-end components. The components of the system can be interconnected by any form or medium of digital data communication (e.g., a communication network). Examples of communication networks include a local area network (LAN), a wide area network (WAN) and the Internet.

The computer system can include a client and a server. The client and server are generally remote from each other and typically interact through a communication network. The relationship of client and server arises by virtue of computer programs running on respective computers and having a client-server relationship to each other. The server may be a cloud server, a server of a distributed system, or a server combined with blockchain.

It should be appreciated that, all forms of processes shown above may be used, and steps thereof may be reordered, added or deleted. For example, as long as expected results of the technical solutions of the present disclosure can be achieved, steps set forth in the present disclosure may be performed in parallel, performed sequentially, or performed in a different order, and there is no limitation in this regard.

The foregoing specific implementations constitute no limitation on the scope of the present disclosure. It is appreciated by those skilled in the art, various modifications, combinations, sub-combinations and replacements may be made according to design requirements and other factors. Any modifications, equivalent replacements and improvements made without deviating from the spirit and principle of the present disclosure shall be deemed as falling within the scope of the present disclosure.

What is claimed is:

1. An image processing method implemented by an electronic device, the image processing method comprising:
obtaining a first categorical feature and M first image features corresponding to M first images respectively, each first image being associated with a task index of a set of task indices, the task indices of the set of task indices associated with different first images being different from each other, M being a positive integer;
fusing the M first image features with the first categorical feature respectively so as to obtain M first target features;
performing feature extraction on the M first target features so as to obtain M second categorical features;
selecting from the M second categorical features a second categorical feature corresponding to each task index, and performing regularization corresponding to the task index on the second categorical feature, so as to obtain a third categorical feature corresponding to the task index; and
performing image processing in accordance with M third categorical features so as to obtain M first image processing results of the M first images.

2. The image processing method according to claim 1, wherein selecting the second categorical feature corresponding to each task index and performing regularization corresponding to the task index on the second categorical feature so as to obtain the third categorical feature corresponding to the task index comprises:
performing feature counting on the second categorical feature selected from the M second categorical features corresponding to the task index, so as to obtain first feature statistical information about a task corresponding to the task index; and
performing a normalization operation on the second categorical feature corresponding to the task index in accordance with the first feature statistical information, so as to obtain the third categorical feature corresponding to the task index.

3. The image processing method according to claim 2, wherein the first feature statistical information comprises a feature data average and a feature data variance corresponding to the task index.

4. The image processing method according to claim 1, wherein performing the feature extraction on the M first target features so as to obtain the M second categorical features comprises:
performing the feature extraction on each first target feature in the M first target features in accordance with a first network parameter of a feature extraction network in a target model so as to obtain the M second categorical features.

5. The image processing method according to claim 4, wherein the feature extraction network is a visual Transformer network comprising a plurality of encoders, and each encoder comprises a self-attention layer and a feed forward neural network.

6. The image processing method according to claim 1, wherein at least one first image feature of the M first image features corresponding to at least one first image of the M first images is obtained through:
dividing the first image into K image blocks, K being an integer greater than 1;
obtaining an image feature of each image block; and
fusing the image features of the K image blocks so as to obtain the at least one first image feature.

7. The image processing method according to claim 1, wherein:
the first categorical feature is an initial categorical feature, and the first categorical feature is generated randomly or pre-stored;
there is a transition relation between the second categorical feature and the first categorical feature; and
a data distribution of the third categorical feature is the same as a feature data distribution of a task corresponding to the task index.

8. A model training method implemented by an electronic device, the model training method comprising:
obtaining a training sample set, the training sample set comprising N first images, each first image being associated with a task index of a set of task indices, the task indices of the set of task indices associated with different first images being different from each other, N being an integer greater than 1;
inputting the N first images into a target model to perform an image processing operation, so as to obtain N first image processing results of the N first images, the image processing operation comprising,
obtaining a first categorical feature and N first image features corresponding to the N first images respectively,
fusing the N first image features with the first categorical feature respectively so as to obtain N first target features,
performing feature extraction on the N first target features so as to obtain N second categorical features,
selecting from the N second categorical features a second categorical feature corresponding to each task index,
performing regularization corresponding to the task index on the second categorical feature so as to obtain a third categorical feature corresponding to the task index, and
performing image processing in accordance with N third categorical features so as to obtain the N first image processing results of the N first images;
determining a network loss value corresponding to each task index in accordance with the N first image processing results; and
updating a network parameter of the target model in accordance with N network loss values.

9. The model training method according to claim 8, wherein prior to selecting the second categorical feature corresponding to each task index and performing regularization corresponding to the task index on the second categorical feature so as to obtain the third categorical feature corresponding to the task index, the model training method further comprises obtaining historical feature statistical information about a task corresponding to the task index; and
wherein the selecting the second categorical feature corresponding to each task index and performing regularization corresponding to the task index on the second categorical feature so as to obtain the third categorical feature corresponding to the task index comprises:
determining second feature statistical information about the task corresponding to the task index in accordance with the historical feature statistical information and the second categorical feature corresponding to the task index; and
performing a normalization operation on the second categorical feature corresponding to the task index in accordance with the second feature statistical information, so as to obtain the third categorical feature corresponding to the task index.

10. An electronic device, comprising at least one processor, and a memory in communication with the at least one processor, wherein the memory is configured to store therein at least one instruction to be executed by the at least one processor, and the at least one instruction is executed by the at least one processor so as to implement an image processing method, which comprises:
obtaining a first categorical feature and M first image features corresponding to M first images respectively, each first image being associated with a task index of a set of task indices, the task indices of the set of task indices associated with different first images being different from each other, M being a positive integer;
fusing the M first image features with the first categorical feature respectively so as to obtain M first target features;
performing feature extraction on the M first target features so as to obtain M second categorical features;
selecting from the M second categorical features a second categorical feature corresponding to each task index, and performing regularization corresponding to the task index on the second categorical feature, so as to obtain a third categorical feature corresponding to the task index; and
performing image processing in accordance with M third categorical features so as to obtain M first image processing results of the M first images.

11. The electronic device according to claim 10, wherein selecting the second categorical feature corresponding to each task index and performing regularization corresponding to the task index on the second categorical feature so as to obtain the third categorical feature corresponding to the task index comprises:
performing feature counting on the second categorical feature selected from the M second categorical features corresponding to the task index, so as to obtain first feature statistical information about a task corresponding to the task index; and
performing a normalization operation on the second categorical feature corresponding to the task index in accordance with the first feature statistical information, so as to obtain the third categorical feature corresponding to the task index.

12. The electronic device according to claim 11, wherein the first feature statistical information comprises a feature data average and a feature data variance corresponding to the task index.

13. The electronic device according to claim 10, wherein the performing the feature extraction on the M first target features so as to obtain the M second categorical features comprises:
performing the feature extraction on each first target feature in the M first target features in accordance with a first network parameter of a feature extraction network in a target model so as to obtain the M second categorical features.

14. The electronic device according to claim 13, wherein the feature extraction network is a visual Transformer network comprising a plurality of encoders, and each encoder comprises a self-attention layer and a feed forward neural network.

15. The electronic device according to claim 10, wherein at least one first image features of the M first image features corresponding to at least one first image of the M first images is obtained through:
dividing the first image into K image blocks, K being an integer greater than 1;
obtaining an image feature of each image block; and
fusing the image features of the K image blocks so as to obtain the at least one first image feature.

16. The electronic device according to claim 10, wherein the first categorical feature is an initial categorical feature, and the first categorical feature is generated randomly or pre-stored; there is a transition relation between the second categorical feature and the first categorical feature; and a data distribution of the third categorical feature is the same as a feature data distribution of a task corresponding to the task index.

17. An electronic device, comprising at least one processor, and a memory in communication with the at least one processor, wherein the memory is configured to store therein at least one instruction to be executed by the at least one processor, and the at least one instruction is executed by the at least one processor so as to implement the model training method according to claim 8.

18. The electronic device according to claim 17, wherein prior to selecting the second categorical feature corresponding to each task index and performing regularization corresponding to the task index on the second categorical feature so as to obtain the third categorical feature corresponding to the task index, the model training method further comprises obtaining historical feature statistical information about a task corresponding to the task index; and
wherein the selecting the second categorical feature corresponding to each task index and performing regularization corresponding to the task index on the second categorical feature so as to obtain the third categorical feature corresponding to the task index comprises:
determining second feature statistical information about the task corresponding to the task index in accordance with the historical feature statistical information and the second categorical feature corresponding to the task index; and
performing a normalization operation on the second categorical feature corresponding to the task index in accordance with the second feature statistical information, so as to obtain the third categorical feature corresponding to the task index.

19. A non-transitory computer-readable storage medium storing therein at least one computer instruction, wherein the at least one computer instruction is called and executed by at least one processor of an electronic device so as to implement the image processing method according to claim 1.

20. A non-transitory computer-readable storage medium storing therein at least one computer instruction, wherein the at least one computer instruction is called and executed by at least one processor of an electronic device so as to implement the model training method according to claim 8.
